(19) United States
(12) Patent Application Publication
(10) Pub. No.: US 2017/0215439 A1
(43) Pub. Date: Aug. 3, 2017

(54) MEAT TENDERIZING USING SUBSTRATE WITH PHASE CHANGE MATERIALS

(71) Applicant: EMPIRE TECHNOLOGY DEVELOPMENT LLC, Wilmington, DE (US)

(72) Inventor: Georgius Abidal ADAM, Sydney (AU)

(21) Appl. No.: 15/011,425

(22) Filed: Jan. 29, 2016

(51) Int. Cl. A22C 9/00

(52) U.S. Cl. CPC A22C 9/002

(57) ABSTRACT

A meat tenderizing device is provided for meat tenderizing. The device can include a substrate having at least one structural reinforcing member. The substrate may be elastomeric, and may have a body of a material that is non-conductive. The structural reinforcing member can be longitudinally aligned to inhibit longitudinal shortening or longitudinal contraction of the device. The device can provide radial or lateral compression to maintain a longitudinal length or longitudinal stretching of meat contained therein. The substrate can include a conductive material distributed therein that is thermally or electrically conductive. The structural reinforcing member can be positioned so as to control stretching of the substrate. The device can also include a phase change member on a surface of at least a portion of the substrate. The phase change member can include a phase change hydrogel that is liquid at lower temperatures and a gel at higher temperatures.

### BACKGROUND

Meat continues to be a staple food for a large population of people. However, the process of preparing edible meat from an animal may cause damage to the meat. The damage to the meat can occur at different points in the processing of meat. Also, without some processing the meat can be susceptible to the natural process of rigor mortis that results in stiff and tough meat from longitudinal muscle contraction. Accordingly, meat tenderizing processes are sought to reduce the negative consequences of rigor mortis to inhibit shortening and toughening of the meat. Artificially aging meat after harvesting has been used to facilitate breaking down the physical structure of meat to keep the meat tender or relaxed. However, if during the aging the meat undergoes rigor mortis at higher than 35° C. or the pH of the meat is reduced too fast to below 6.0, the sarcomeres of the meat gather together to shorten the length of the muscle fibers and the meat becomes tough, which is referred to as “heat shortening.” If during the aging, the meat is chilled too quickly, the muscle temperature is below 15° C., and the pH of the meat is reduced too slowly, the meat is toughened, which is referred to as “cold shortening.” While various processes are used to inhibit the consequences of rigor mortis, optimal meat processing and tenderizing continues to be researched and developed.

### SUMMARY

In one embodiment, a meat tenderizing device is provided for meat tenderizing. The meat tenderizing device can include a substrate having at least one structural reinforcing member. The structural reinforcing member can be longitudinally aligned to inhibit longitudinal shortening or longitudinal contraction of the substrate of the device. The meat tenderizing device can provide radial or lateral compression to maintain a longitudinal length or to induce longitudinal stretching of meat contained therein. The device can include a conductive material that is thermally or electrically conductive. The at least one structural reinforcing member can be positioned so as to control stretching of the substrate. The substrate can be any material that may be stretchable or a material that does not allow stretching. The meat tenderizing device can also include a phase change member on a surface of at least a portion of the substrate. The phase change member can include a phase change material (PCM) that is liquid at lower temperatures and a gel at higher temperatures. The meat tenderizing device can be a bag, sleeve, sheet, or strip. The gel can be any type of gel from flowable gel to solid gel.

In one embodiment, a method of tenderizing meat is provided. The meat tenderizing method can include providing a meat tenderizing device in accordance with an embodiment described herein. The meat tenderizing method can also include placing meat in the meat tenderizing device, and inhibiting muscle contraction of the meat. The meat tenderizing method can include sealing the meat tenderizing device having the meat therein. Such sealing can allow for the phase change member to contour to the meat at a lower temperature below the melting point of the phase change member. Then, the phase change member can expand and solidify at a higher temperature above the melting point so as to inhibit muscle contraction of the meat.

In one embodiment, a meat tenderizing system is provided. The meat tenderizing system can include a meat tenderizing device in accordance with one of the embodiments, which is configured for meat tenderizing. The meat tenderizing system can also include an electrical device that is configured to provide electricity to a conductive member or composition of the bag when electrically connected thereto.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and following information as well as other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1A illustrates an embodiment of a meat tenderizing device.

FIG. 1B shows an end view of the meat tenderizing device of FIG. 1A.

FIG. 2 illustrates an embodiment of a meat tenderizing system.

FIGS. 2A-2E illustrate different embodiments of conductive substrates, which have a substrate matrix with one or more conductive members.

FIG. 3 shows an embodiment of a stretching system.

FIG. 4 illustrates an embodiment of a sheet that can be folded into a bag or wrapped around a carcass.

FIG. 5 shows examples of embodiments of structural reinforcing members.

FIG. 6 shows an embodiment of a pocket of a substrate member that contains a PCM.

FIG. 7 shows an embodiment of a double sleeve of two concentric members that have a chamber therebetween that has the PCM.

FIG. 8 shows an embodiment of a meat tenderizing bag that has annular rings.

FIG. 9 illustrates the expansion of the PCM as it transitions from a thin liquid to a thicker hydrogel.

The elements of the figures are arranged in accordance with at least one of the embodiments described herein, and which arrangement may be modified in accordance with the disclosure provided herein by one of ordinary skill in the art. The elements of the figures are shown generically and can vary in shape, size, and orientation, and any element of any figure can be combined with the other elements of other figures.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

Generally, the present technology relates to a meat tenderizing device having a substrate lined with a phase change material (PCM) that can be used to inhibit shortening (e.g., longitudinal) and toughening of muscles during a meat tenderizing process. As such, the meat tenderizing device can inhibit shortening of the muscles in a general longitudinal direction of the muscles. The meat tenderizing device can be configured to apply radial or lateral compression to muscles contained therein to inhibit shortening of the muscles and/or to induce longitudinal stretching of the muscles. The meat tenderizing device can be designed to receive one or more muscles having muscle fibers (e.g., optionally in the longitudinal direction) so that the muscle does not longitudinally shorten. Accordingly, different meat tenderizing devices can have different configurations depending on the type of carcass, carcass portion, muscle, the cut, or the size of the carcass or meat, and whether or not the carcass or meat contains the bone or has been deboned. The meat tenderizing device can be configured as a bag or sleeve that can receive the carcass or meat therein, or configured as a sheet or strip that can be wrapped around the carcass or meat. The meat tenderizing device can be applied to the carcass or meat in order to apply radial or lateral compressive forces that inhibit shortening of the muscles. Such compressive forces can be sufficient to lengthen the muscles.

In one embodiment, the meat tenderizing device can be used to apply compressive pressure to the carcass or meat. Such compressive pressure can inhibit longitudinal shortening of the muscles by the orientation in the muscle fibers that is caused by the compressive pressure. The orientation refers to the muscle fibers being oriented in a common direction, such as a longitudinal direction. The orientation can result in 0% shortening of muscles up to 10% extension of the muscles. The PCM thickness and expansion thickness can be changed to change the amount of compressive pressure applied to the muscles, and thereby change the orientation of the muscle fibers.

In one embodiment, a meat tenderizing bag is configured to have a longitudinal direction that generally matches the longitudinal direction of the muscle fibers (e.g., by being about 1 to 20 or 2 to 15 degrees relative to the longitudinal direction) of one or muscles of a carcass or cut of meat contained therein, or generally aligns with the carcass or cut of meat so that compressive forces can be applied thereto. The meat tenderizing bag can apply compressive forces to the carcass or meat contained therein to inhibit longitudinal shortening of one or more of the muscles of the carcass or meat. The meat tenderizing bag may apply compressive forces that are sufficient to lengthen the muscles. In one aspect, the meat tenderizing bag does not apply compressive forces to ends of the carcass or meat that may induce shortening.

In one embodiment, a meat tenderizing sheet or strip can be of sufficient dimensions (e.g., length and width) so that the sheet or strip can be wound around the carcass or meat to contain the carcass or meat therein. The sheet or strip can apply compressive forces to the carcass or meat contained therein to inhibit longitudinal shortening of one or more muscles of the carcass or meat. The meat tenderizing sheet or strip may apply compressive forces that are sufficient to lengthen the muscles. In one aspect, the meat tenderizing sheet or strip is arranged or wrapped around the carcass or meat so that the sheet or strip does not apply compressive forces to ends of the carcass or meat that may induce shortening.

The compressive forces applied by the meat tenderizing device can be used for inhibiting longitudinal shortening of the meat due to the orientation of the meat tenderizing device relative to the carcass or muscle that is created by the applied pressure that is generated by the expansion of the PCM against the carcass or meat. Such expansion of the PCM can provide for no contraction of the muscles (e.g., inhibits shortening) or even provide longitudinal stretching up to 10% extension of the muscles. The change in thickness of the PCM lining layer upon converting from liquid to gel can provide the pressure (e.g., compression) applied to the carcass or meat. In one aspect, the meat tenderizing device can be configured to promote radial or lateral compression of the meat, and thereby inhibit the meat from longitudinally shortening. Such radial or lateral compression can promote longitudinal stretching. Often, meat radially or laterally expands so as to cause longitudinal shortening during rigor mortis, and by inhibiting such radial or lateral expansion, the unfavorable longitudinal shortening is inhibited.

In one embodiment, a meat tenderizing bag is designed to fit the whole carcass in the longitudinal direction. That is, the carcass is oriented longitudinally in the longitudinal direction of the meat tenderizing bag. This allows the meat tenderizing bag to extend the carcass in the longitudinal direction and/or prevent contraction of the muscle during a cooling cycle of the meat tenderizing process. The expanding PCM can swell against the carcass and provide the compressive force to the carcass to extend the carcass in the longitudinal direction and/or prevent contraction of the muscle during the cooling cycle of the meat tenderizing process. The meat tenderizing bag can be designed to accommodate half carcass, quarter carcass or other portion of a carcass.

The meat tenderizing bag can be configured with multiple sections with different longitudinal directions relative to each other, which can be used for cuts of meat that have multiple general longitudinal orientations. In one aspect, the direction of a bone can be used for the longitudinal directional orientations relative to the muscle attached thereto, and joints can include bones at different angles so that the bag has different sections with different longitudinal orientations to accommodate different cuts of meat that have one or more joints and two or more bones. A multi-sectioned meat tenderizing bag can be adapted to fit around a cut of meat or a whole, half, quarter, or other fraction of the carcass. Alternatively, the bag can be a tube or sleeve with a single conduit with a longitudinal direction that is configured to fit around a cut of meat or a whole, half, quarter, or other fraction of the carcass, where the longitudinal direction is relative to the overall directional orientation of the cut of muscle or carcass, or of the bag.

In one aspect, the meat tenderizing sheet or strips can be wrapped around any part of the carcass or portion thereof. The sheets or strips can be used by being wrapped around a cut, such as foreleg, forequarter, or for cuts having no bones or one or more bones.

The meat tenderizing device can be used in processes for tenderizing meat. The meat tenderizing device can be used with meat soon after harvesting in order to inhibit the negative consequences of rigor mortis. As such, the meat tenderizing device can be used to inhibit post-harvest muscle contractions in a carcass or portion thereof (e.g., half carcass, quarter carcass etc.) or meat portions thereof with or without bone. The meat tenderizing device may also inhibit shortening or swelling of the meat. By inhibiting the negative consequences of rigor mortis and muscle contractions (e.g., longitudinal) and shortening or swelling of the meat (e.g., radial or lateral), the meat tenderizing device can reduce meat toughness or inhibit the onset of meat toughness. The meat tenderizing device can be used during a process of aging meat. The meat tenderizing device can allow for the glycogen within the meat to facilitate breaking down the physical structure of the muscle so that the meat becomes tenderer. The meat tenderizing device can facilitate a reduction in the pH of the meat from 7 to 5.4 at a controlled pH change and a controlled temperature change.

The meat tenderizing device can provide for mechanical stretching (e.g., longitudinal) or super stretching of the muscles in the meat in order to produce high value tenderized meat. Such mechanical stretching can be induced by compression. The meat tenderizing device can inhibit meat therein from contracting in order to improve meat tenderness. The meat tenderizing device can be used to provide a compression force (e.g., radial or lateral) to the meat so as to stretch or lengthen (e.g., longitudinally) the meat in order to improve meat tenderness.

The PCM can be selected based on experimental testing to optimize the composition. The PCM can be evaluated by thermal analysis (e.g., DSC) to identify the amount of heat required to increase the temperature of the PCM. This can allow for optimizing the PCM so that the temperature change can be controlled by the PCM material. The design process can include identifying a PCM heat intake capacity by measuring the enthalpy change as a function of cooling or heating of the PCM.

The PCM of the meat tenderizing device can be optimzed and selected so that in the cooling cycle, the cooling condition can keep the temperature of the caracass between 35° C. and 15° C. This allows for controlling the cooling rate by selecting a PCM with a transition temperature between this range. The transition temperature of the PCM can be selected to prevent hot shortening or cold shortening. Accordingly, the meat tenderizing process can have a resulting pH change that is a function of the rate of cooling of the carcass accompanied with inducing pressure (e.g., compression) due to expanding the PCM. As such, the expanding PCM can act as a cooling agent to draw heat from the carcass. Thus, the expanding PCM can prevent contraction of the muscles in the meat tenderizing device, and in come instances the expanding PCM can cause the muscles to extend or lengthen. It has been found that the pH change of meat depends directly on the rate of temperature change. It has also been found that pH change of meat can be controlled by controlling the electrical pulses that induce the glycolysis reaction in the meat. The pH can be measured with a pH measuring unit or pH strips that indicate the pH. The temperature of the meat in the meat tenderizing device can be measured with a temperature measuring device, such as with a thermocouple and/or thermometer and/or touchless temperature sensing (e.g., infrared etc.). The temperature change can be controlled by selecting an appropriate PCM material and PCM thickness when gelled. Thus, the change in pH and temperature of the meat in the meat tenderizing device can depend on the type of PCM that is used, where the PCM is a cooling lining on the substrate of the device. The PCM can be selected based on the desired temperature range of the transition temperature.

The meat tenderizing device can be used to improve temperature regulation of the meat during tenderizing. The meat tenderizing device can be used to inhibit water from evaporating from the meat that is being processed therein. The meat tenderizing device can inhibit the formation of surface moisture on the meat from water drawn from inside the meat. The meat tenderizing device can inhibit evaporation of surface moisture from the meat. Accordingly, the meat tenderizing device can maintain the water content in and on the meat so that the meat does not lose water content or moisture during processing. Retention of water and moisture in and on the meat can retain or even improve meat tenderness and thereby provide higher quality meat. The meat tenderising device keeps the water content in the meat as it prevents evaporation and sublimation of water or frozen during the cooling process because the bag, sheet, or strip embodiments provide a closed system that does not allow the water to escape (e.g., being water tight) secondly the cooling process is through PCM.

The methods of processing the meat described herein with use of the meat tenderizing device can be performed at controlled temperatures and temperature change profiles. The meat processing can inhibit onset of rigor mortis at a temperature higher than 35° C. The methods of processing the meat described herein with use of the meat tenderizing device can be done at controlled pH change profiles. The meat processing can inhibit the pH in the meat from decreasing too fast to below a pH of 6.0. As such, the meat processing can inhibit the sarcomeres in the meat from gathering together to radially or laterally expand the meat. Thus, the meat processing with the meat tenderizing device can inhibit “heat shortening” of the meat.

Also, the meat processing methods can inhibit the meat from being chilled too quickly. The meat processing can inhibit the meat from reaching a muscle temperature at or below 15° C. too quickly. The meat processing may also inhibit the meat from having a reduction in pH occur too slowly. By inhibiting too much cooling and/or too slow pH reduction, the meat processing with the meat tenderizing device can inhibit meat toughening, and thereby inhibit “cold shortening” of the meat.

A meat tenderizing device that includes a suitable PCM as a liquid on the substrate (e.g., bag, sheet, or strip) when it is cold will take the dimension of the carcass or meat when enclosed therein. When the meat tenderizing device encloses the carcass or meat, the change in temperature via the PCM absorbing energy (e.g., transition from liquid to gel) is gradual. The transition temperature or amount of heat needed to cause the transition from liquid to gel can be tailored as required for different animal carcasses or cuts of meat in order to control the cooling rate. Such tailoring of the PCM can be choosing the suitable type of PCM that can provide the expanding hydrogel at a suitable transition temperature, and by providing a certain amount of the PCM to obtain a desired volumetric expansion from liquid to gel.

It has been found that promoting the breakdown of glycogen during meat processing can improve the tenderness in the processed meat. It is thought, without being bound thereto, that breaking down glycogen can provide glucose during the meat processing in order to facilitate enzymatic processes that can improve meat tenderness. Accordingly, the meat processing with the meat tenderizing device can be performed to breakdown the glycogen to improve meat tenderness. The meat processing can include using high voltage electrical stimulation to breakdown the glycogen to lactic acid (which can assist with pH reduction), where electrical stimulation can be provided to the meat tenderizing device for delivery to the meat therein or can be directly applied to the carcass inside the device using electrodes installed in the carcass. Also, enzymatic breakdown of glycogen can also be optimized with the meat processing.

The meat can be enclosed within the meat tenderizing device, and the meat tenderizing device can apply radial or lateral mechanical forces to push and compress the meat inwardly. The radial or lateral mechanical forces can inhibit longitudinal contraction of the muscles in the meat in order to enhance meat tenderizing. The radial or lateral compression can be performed during a cooling protocol that cools the meat at a controlled cooling rate or controlled cooling temperatures. The radial or lateral compression and cooling can be performed in a manner that facilitates a reduction in pH in the meat in a controlled manner. The radial or lateral compression may also be accompanied with breaking down glycogen in the meat to produce glucose. The breaking down of glycogen can be by enzymatic processing by natural enzymes, or can be by electricity (e.g., electrical pulses) applied to the meat via the meat tenderizing device. The meat tenderizing device can improve meat tenderizing by imparting mechanical radial or lateral compression under a controlled rate of cooling that leads to controlled reduction of pH. The meat tenderizing may also be improved by using electrostatic or enzymatic cleaving of glycogen.

The meat tenderizing device can be configured in different shapes and sizes and forms in order to facilitate meat tenderizing. As such, the shapes, sizes, and forms shown in the figures are generic examples. The meat tenderizing device can include a substrate having at least one structural reinforcing member. The substrate can be stretchable such that the structural reinforcing member inhibits or controls stretching in one or more directions. The substrate can be a conductive substrate, and can include a conductive material that is thermally or electrically conductive, or both thermally and electrically conductive. In one example, the substrate material can be insulating material with conductive particles or members distributed therein such that the substrate material can conduct electricity. In one example, the substrate material can be an elastomeric or rubber material (e.g., natural or synthetic) that is not conductive, and that has conductive particles such as conductive acetylene carbon filler or members to provide the substrate with electrical conduction characteristics. The structure of the substrate can be a sheet that folds and is formed into a bag, a bag with one opening, or a tubular bag with two openings at opposite ends such as a sleeve. As discussed herein, the substrate may be in the form of a sheet or sleeve that can be closed to form a bag. In any event, the substrate can be formed to retain the meat therein and optionally sealed and fluid tight. The at least one structural reinforcing member can be positioned in the substrate so as to control or inhibit longitudinal shortening of the substrate. This allows the structural reinforcing members to be arranged in a manner that controls the longitudinal stretching evenly across a surface of the meat, or across the entire external surface of the meat. The meat tenderizing device can include a PCM that can be located on a surface of at least a portion of the substrate. The PCM can include any material that can undergo a phase change from being liquid when cooler to gelatinous or solid when warmer. In one aspect, the phase change member can include a phase change hydrogel that is liquid at lower temperatures and a gel at higher temperatures.

In one example, the meat tenderizing device can include substrate having the PCM thereon. The substrate can be in the form of a bag, sleeve, sheet, or strip. The substrate can include a zipper along one side that can be wrapped around the carcass or meat, and zipped to encapsulate to carcass or meat. Another example can be a double layer (e.g., substrate and PCM) sheet where the PCM is wrapped around the carcass and closed with a fastener, such as belts, ropes, clips, or the like that can fasten a wrap closed. The structure of the bag can be a sheet that folds and is formed into a bag, a bag with one opening, or a tubular bag with two openings at opposite ends such as a sleeve. The sheet or strips can be wrapped around the carcass and fashioned into a bag that encloses the carcass.

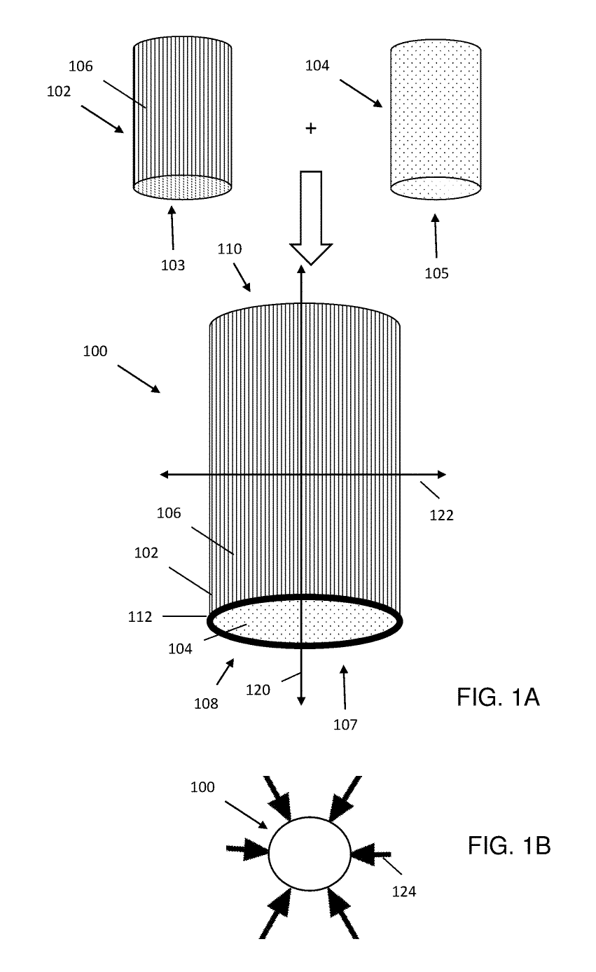

FIG. 1A illustrates a meat tenderizing device 100 that is formed from a substrate 102 and a PCM 104, which are shown separately. The meat tenderizing device includes an outer substrate 102 (e.g., in form of a bag) having an internal lumen 103 and an inner PCM 104 having an internal lumen 105, where the inner PCM 104 is on an internal surface of the substrate 102 in the internal lumen 103. As such, the internal lumen 103 of the substrate 102 and internal lumen 105 of the PCM 104 forms the inner lumen 107 of the meat tenderizing substrate device 100. The substrate 102 includes structural reinforcing members 106, which as shown by the vertical parallel lines of the substrate 102 to represent two or more parallel strips that are longitudinally oriented. The meat tenderizing device is shown with an open first end 108 and a second end 110. The second end 110 can be either open or closed. The open first end 108 may include a closing member 112 (e.g., illustrated by dark ring) that can be used to close and/or seal the open first end 108 to a closed first end 108. For example, the closing member 112 can be a tongue and groove closing member, such as Ziploc®, or can be a zipper, or any other member capable of closing the open first end 108. Twist ties, cinch fasteners, wire, rope, or other member that can close the first end 108 may also be used as the closing member 112, and may be separate from the substrate 102.

Arrow 120 shows the longitudinal direction of the meat tenderizing device 100, which in use is aligned with the longitudinal orientation of the meat as defined by the longitudinal muscle fibers of the meat. Arrow 122 shows the lateral direction of the meat tenderizing device 100, which is orthogonal with the longitudinal direction of the meat tenderizing device 100 and the longitudinal direction of the muscle fibers of the meat when contained therein. FIG. 1B shows an end view of the meat tenderizing device 100, which can be tubular, and arrows 124 show the radial directions relative the meat tenderizing device 100 and any meat contained therein. These directional orientations are used herein to describe features of the meat tenderizing device 100 as well as the use thereof in a meat tenderizing process. However, for complex cuts of meat, the radial direction can be relative to a surface of the meat, and the longitudinal direction can include one or more different sections, each section can have a different longitudinal direction relative to other sections. Application of a compressive force to a surface of meat can be considered to be the radial or lateral force, where the substrate is oriented relative to the meat so that forces are not applied in directions that the meat is stretched in. For example, compressive forces are not applied to meat surfaces to be stretched away from each other.

In one embodiment, a kit can be provided with the substrate 102 and a liquid reservoir that has the liquid PCM 104. The liquid PCM 104 can be applied to either the substrate 102 or meat before the meat is placed in the substrate 102.

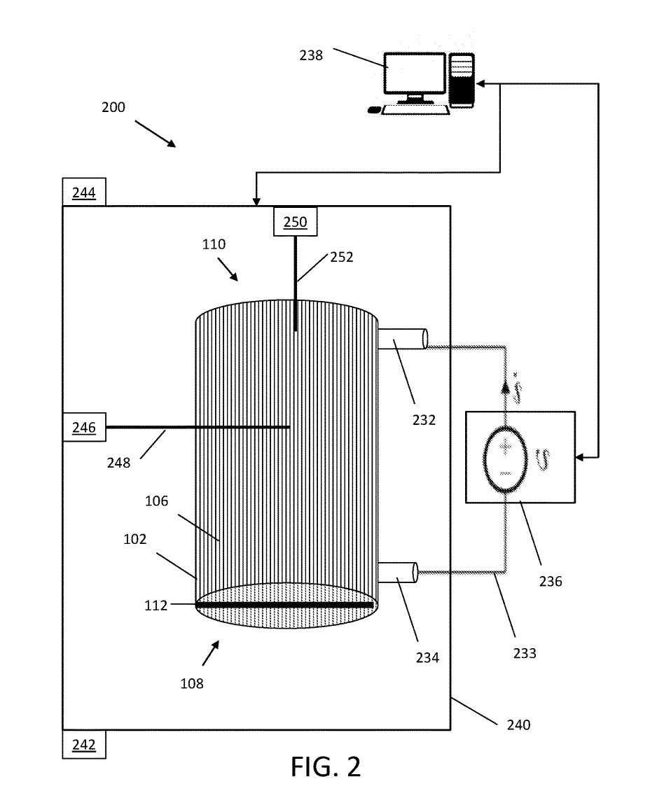

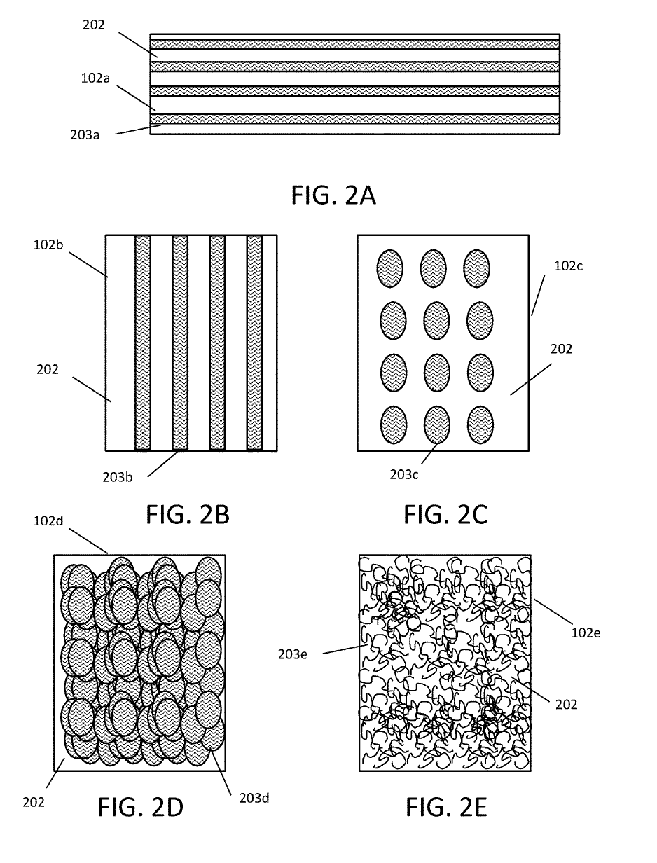

FIG. 2 illustrates a meat tenderizing system 200 that includes a meat tenderizing device 100 having a first electrode 232 and second electrode 234 connected to an electrical supply 236. As shown, the first electrode 232 is at one end and the second electrode 234 is at the other end; however, the electrodes 232, 234 may be located anywhere feasible so that the system 200 can function to tenderize meat as described herein. The electrodes 232, 234 may also be separate or from the meat tenderizing device 100 so as to be used with or without the substrate 102. That is, the electrodes 232, 234 may be attached to the carcass or meat with or without the substrate 102, and the substrate 102 may be included over the electrodes 232, 234 can be used as standard in the art, with one electrode installed in the carcass at one location (e.g., rectum) and one electrode installed in the carcass an another location (e.g., mouth, nose, or elsewhere). The substrate 102 can include conductive members or conductive substances that can transfer the electricity through the PCM 104 to the meat, which is shown in FIGS. 2A-2E. While the electrodes 232, 234 are illustrated, they may be omitted and electrical lines 233 can connect directly to the substrate 102. The electrical supply device 236 can provide the electricity in any form and in any way, such as pulses, direct current (DC), alternating current (AC), or the like and at any current, voltage or other parameter that is suitable for enhancing meat tenderizing. Optionally, the electrical supply device 236 may be electrically coupled with a computing system 238 that can control how the electrical supply device 236 provides the electricity. Accordingly, the computing system 238 can include a non-transitory memory device (not shown) that has computer executable instructions to implement an electrical protocol that provides electrical pulses from the electrical supply 236 to the meat tenderizing device 100. FIG. 2 also shows the closing member 112 closed so as to close the first end 108.

The electrical stimulation can apply the voltage and pulses from different parts of the carcass. In one example, a positive electrode can be installed in the carcass at any first point, and the negative electrode can be installed at any second point so that the carcass forms a closed circuit with the two electrodes.

FIG. 2 also shows the system 200 having a temperature regulating device 240 that can have a heating element 242 and/or a cooling element 244 along with a temperature sensor 246 that can optionally include a thermocouple 248 that enters through the device, which can be at any location. The temperature sensor 246 may also be touchless and use radiant or laser temperature sensors. The heating element 242 can provide heat to the meat tenderizing device 100 so as to heat and/or control temperature of the meat as measured by the temperature sensor 246. The cooling element 244 can provide cooling to the meat tenderizing device 100 so as to cool and/or control temperature of the meat. Optionally, the temperature regulating device 240 can be operably coupled with the computing system 238 so that the computing system 238 can control the temperature and temperature change profiles of the meat tenderizing device 100 and meat. Accordingly, the computing system 238 can include a non-transitory memory device (not shown) that has computer executable instructions to implement a temperature control protocol and/or temperature change protocol so as to control the temperature regulating device 240. The temperature sensor 246 can be operably coupled to the computing system 238 so that temperature data can be used to control the heating element 242 and/or cooling element 244. In one option, the cooling element 244 can be a cooling room that contains the meat tenderizing device 100. In one option, the heating element 242 can be omitted.

FIG. 2 also shows the system having a pH meter 250 that is coupled to a pH probe 252 that can be extended into the internal portion of the substrate 102 so that the pH of the meat and/or environment around the meat can be measured and monitored in order to provide pH data to the computing system 238. The computing system 238 can compare the pH data to control pH parameters and then adjust the protocol according, such as by changing the electricity provided to the meat or changing the temperature or temperature change rate or changing the tension and/or compression forces applied to the meat by the system 200.

FIGS. 2A-2E illustrate different embodiments of conductive substrates 102a-e, which have a substrate matrix 202 with one or more conductive members 203a-e. FIG. 2A shows the substrate matrix 202 having longitudinal conductive members 203a in the form of strips. FIG. 2B shows the substrate matrix 202 having lateral conductive members 203b in the form of vias. FIG. 2C shows the substrate matrix 202 having particulate conductive members 203c that do not touch and conduct via capacitance. FIG. 2D shows the substrate matrix 202 having particulate conductive members 203d that touch and conduct. FIG. 2E shows the substrate matrix 202 having fibrous conductive members 203e that touch and conduct, or may be separate and conduct via capacitance.

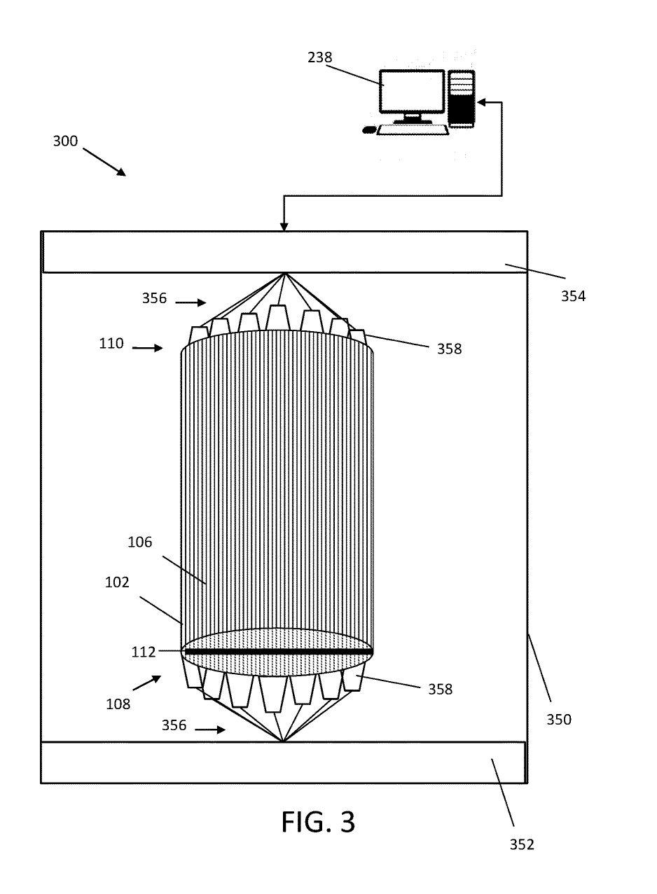

FIG. 3 shows a stretching system 300 that can be used to longitudinally stretch the substrate 102 so as to longitudinally stretch the meat in accordance with the longitudinal orientation of the muscle fibers. The stretching system 300 can include a stretching device 350 that can include a first stretching member 352 and a second stretching member 354 that pull and stretch in opposite directions along the longitudinal direction. The first and second stretching members 352, 354 can be connected to force transfer members 356 (e.g., cables, wires, rope, etc.) that are connected to stretch fasteners 358 on both ends (e.g., first end 108 and second end 110) of the substrate 102. The stretching device 350 can include any type of mechanisms or mechanical components for the first stretching member 352 and second stretching member 354 that pull and stretch in opposite directions. Also, one of the first stretching member 352 or second stretching member 354 can be omitted and instead the force transfer members 356 can be attached to a fixed member so that the longitudinal forces can be applied with only one mechanical mechanism. Optionally, the stretching device 350 can be operably coupled with the computing system 238 so that the computing system 238 can control the tension and stretching profiles that are applied to the substrate 102 of the meat tenderizing device 100 and to the meat contained therein. Accordingly, the computing system 238 can include a non-transitory memory device (not shown) that has computer executable instructions to implement a tension control protocol and/or stretching change protocol so as to control the longitudinal forces tension forces applied to the substrate 102.

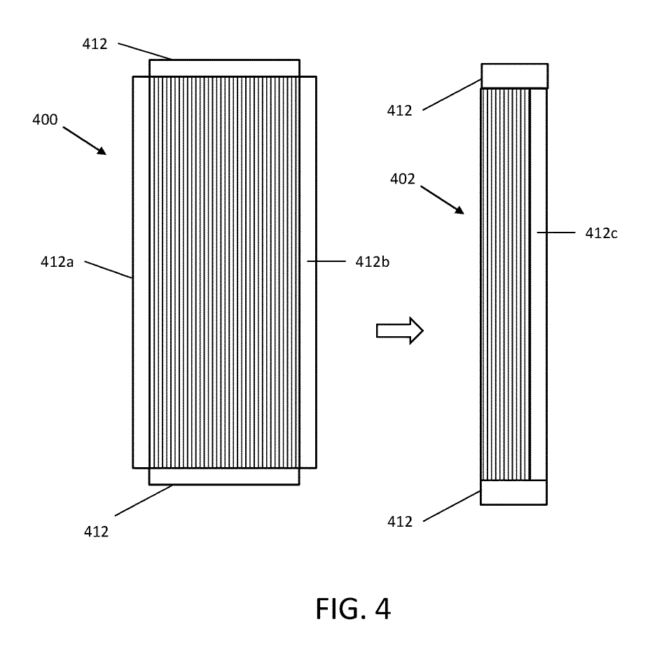

FIG. 4 illustrates an embodiment of a sheet 400 that can be folded into a bag 402 in accordance with the description described herein. As show, the sheet 400 includes end closing members 412 on each end that can be similar to the closing member 112. The sheet 400 also includes side closing members 412a, 412b that can be combined when the sheet 400 is folded. The side closing members 412a, 412b can combine to make a bag 402 or sleeve, such as shown in the figures. When combined, side closing members 412a, 412b form a seal 412c. The closing members 412a, 412b can be tongue and groove sealing members or zipper sides that zip together, or any other way to form a bag or sleeve from a sheet. The illustration may also show an embodiment of a strip, which may include or omit the closure members 412, 412a, 412b, where the strip can be wound around the carcass or meat.

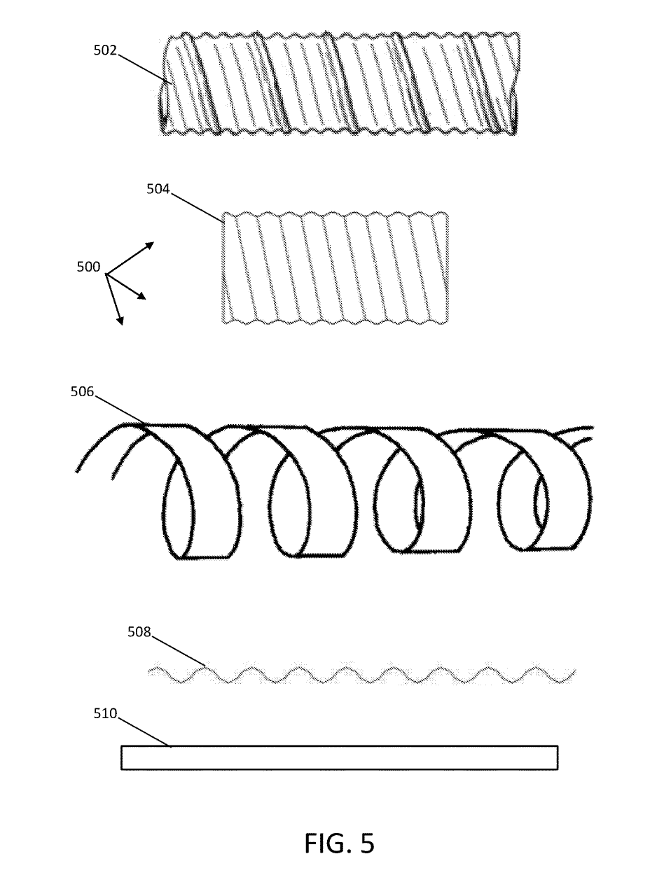

FIG. 5 shows examples of structural reinforcing members 500 that can be included inside the substrate, within the body of the substrate, or outside of the substrate. As show, the structural reinforcing members 500 can include: a corrugated spiral 502 where the turns can be touching or separated into a helix; a corrugated tube 504; a helix 506; a corrugated strip 508; and/or a flat strip 510. However, any structural reinforcing member 500 can be used. Also, the corrugated spiral 502, corrugated tube 504, or helix 506 can also limit radial or lateral expansion of the substrate, and thereby inhibit radial or lateral expansion of the meat.

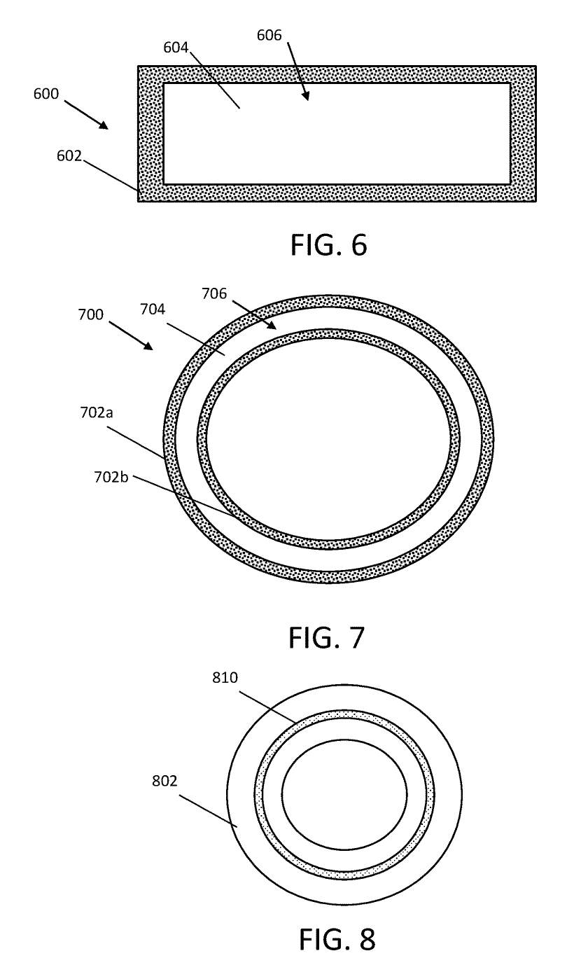

FIG. 6 shows a pocket 600 of a member 602 that forms part of a substrate. The pocket 600 has an internal chamber 606 that contains the PCM 604. The pocket 600 can be any dimension, and one or more pockets 600 can be distributed in the substrate.

FIG. 7 shows a double sleeve 700 of two concentric members 702a, 702b that have a chamber 706 therebetween that has the PCM 704 therein. The double sleeve 700 can form the bag or a portion thereof such that one or more double sleeves 700 may form the bag.

FIG. 8 shows a bag 802 that has annular rings 810. Any number of annular rings 810 can be distributed from one end to the other end of the bag 802. The annular rings can be annular reinforcing members that inhibit the bag 802 from expanding radially or laterally. As such, the annular rings 810 can inhibit shortening of the meat. The annular rings 810 can be inside the lumen of the bag 802, within the body of the bag 802 (as shown), or outside the bag 802.

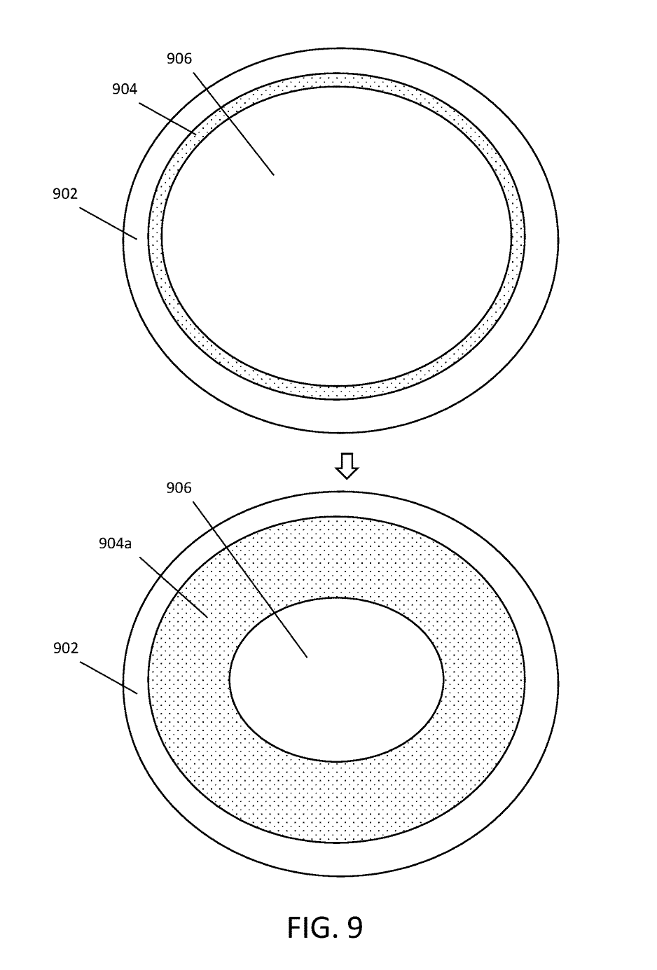

FIG. 9 illustrates the expansion of the PCM 904 as it transitions from a thin liquid 904 to a thicker solid hydrogel 904a. The bag 902 (e.g., elastomeric bladder or sleeve) may radially stretch, but can provide resistance so that expansion to the thicker solid hydrogel 904a applies radially compressive forces to the meat 906.

The substrate can be made of any type of material. The material may be stretchable or non-stretchable. A stretchable material can be an elastomeric or rubber material or have the properties thereof. Non-limiting examples of the elastomeric material can include nitrile rubber, ethylene-propylene copolymers, fluorinated polymers, chloroprene rubber, silicone rubber, fluorosilicones, polyacrylates, ethylene acrylics copolymers, styrene-butadiene copolymers, polyurethane, polyisoprene, polybutadiene, polyisobutylene, natural rubbers, other synthetic rubbers, derivatives thereof, similar materials, and combinations thereof. In one aspect, the material that forms the substrate may be non-conductive so that it does not conduct electricity or heat. As such, conductive materials can be included in a substrate that has a non-conductive body.

The substrate can include a conductive material distributed therein, such as is shown in FIGS. 2A-2E. The distribution can be in any manner such as homogeneous or in a gradient or random. The conductive material can be in particles or in fibers or members (e.g., electrodes). The conductive material in the substrate can be selected from the group consisting of carbon fibers, acetylene carbon, carboxylated rubber, ionic thermoplastic elastomers, ethylene-propylene-diene rubber, metal particles, fibers, or members, other conductive materials, or combinations thereof.

The meat tenderizing device can have various features and configurations to facilitate the meat tenderizing process described herein. The structural reinforcing member can be selected from the group consisting of a spiral structure, helical structure, corrugated spiral structure, corrugated helical structure, corrugated tube fibers, elongatable fibers, ribbons, flat ribbons, corrugated ribbons, strips, corrugated strips, two or more parallel members, or combinations thereof or other similar members. The structural reinforcing members can be elongate and have the long elongated dimension aligned in the longitudinal direction of the substrate (e.g., bag, sleeve, sheet, or strip). The elongate members may also be at angles relative to the longitudinal direction. The elongate members may or may not be laterally aligned in a manner that does not resist longitudinal shortening. However, other formations or locations or orientations can be used for the structural reinforcing member. The structural reinforcing member can be any material that can structurally reinforce a substrate (e.g., elastomeric bag), such as plastics, metals, ceramics, composites, or any other rigid material or material having less flexibility or elasticity than the substrate. The structural reinforcing members may be configured to control the stretching ratio.

The structural reinforcing members may also be conductive. As such, the structural reinforcing members may be made from a material selected from the group consisting of carbon fibers, carboxylated rubber, ionic thermoplastic elastomers, ethylene-propylene-diene rubber, metals, or combinations thereof. However, these conductive materials may also be used as fillers in the substrate to order to impart the conductive property to the material of the substrate that is not conductive without the fillers. Examples of conductive reinforcing materials include carbon fibers, metal fibers, or fibers made from other conductive polymers, such as polyphenylene, polyaniline, or polyacetylene copolymers. The structural reinforcing members may be made of materials that are not conductive. Examples of non-conductive reinforcing materials can include polyester fibers, polyamide fibers, polyethylene fibers, isotactic polypropylene fibers, cellulosic fibers, or glass fibres.

The PCM can include an encapsulated hydrogel pocket, where the PCM is a liquid/hydrogel in a polymeric pocket or structural pocket of the substrate (e.g., bag) or as jacketing bag. In one aspect, the PCM can be a liner forming a liner layer on the surface of the substrate, where the liner is liquid at cooler temperatures and solid and/or gel at warmer temperatures. For example, the PCM can be located on an internal surface of the substrate when formed as a bag, sleeve, sheet, or strip with the carcass or meat enclosed therein. However, as described herein, the PCM can be applied to an external surface of the substrate or within one or more chambers within the body of the substrate. The PCM can be a food grade material that is selected from the group consisting of salt hydrates, sugar alcohols, clathrates, paraffins, fatty acids, polyethylene glycols, chitosans, alginate, algae extracts, bagasse, poly(vinyl alcohol), and combinations thereof having a melting temperature of less than 35° C. In any embodiment, the PCM is a liquid at cooler temperatures below the melting point and gel at higher temperatures above the melting point. Generally, the melting temperature can be between −20° C. and 35° C., between −10° C. and 30° C., between 0° C. and 15° C., between 5° C. and 10° C. In one aspect, the melting temperature can be between 0° C. and 35° C., between 5° C. and 30° C., between 10° C. and 25° C., between 15° C. and 20° C., between 20° C. and 25° C., between 10° C. and 30° C., or about 25° C.

The improved meat tenderizing methods may also be facilitated when the meat tenderizing device includes a thermo-reversible PCM. The PCM may be a hydrogel that is liquid when cooler and solid when warmer. Different PCMs may be used for different temperature ranges for different types and sizes of meat. Experimental optimization can be performed to determine the parameters to be implemented for enhanced meat tenderizing. Here, cooler can mean below the melting temperature and warmer means above the melting temperature.

The meat tenderizing device can encapsulate meat and can be used for applying three dimensional radial or lateral compression or longitudinal stretching to the meat in order to facilitate meat tenderizing. The meat tenderizing device can include a thermally and/or electrically conductive elastomeric substrate that includes corrugated spiral structures or parallel strips or other structural features that inhibit longitudinal shortening of the substrate. The substrate can be configured for containing a carcass as a whole, half, quarter, or select parts or individual meat pieces with or without bone so that the muscle fibers are longitudinally aligned with a longitudinal direction of the substrate. The conductive elastomeric substrate (e.g., in form of bag or sleeve) can be dimensioned particularly for different shapes and sizes of meat that are commonly cut by butchers so that the substrate can be fitted to the meat. The substrate can be a stretchable cylindrical bag or sheet that envelops and encloses the meat and formed via a zipper to close the substrate around the meat. The PCM can be included with the conductive elastomeric substrate so that the PCM provides the radial or lateral compressive force to the meat via changing the phase from liquid (e.g., when cooler) to solid (e.g., when heated to body temperature of the harvested meat). Also, external longitudinal stretching can be applied to the conductive elastomeric substrate, such as by mechanical stretching. The conductive elastomeric substrate can have ringlets, loops, or other fastening members that allow for attachment to longitudinal mechanical stretching machines.

In one embodiment, the thickness of the substrate and the thickness of the PCM can be designed according to a desired cooling protocol so that the meat tenderizing device can regulate the rate of cooling in order to avoid either hot shortening or cold shortening.

The conductive substance in the substrate allows for safe application of high energy electric pulses to break down the glycogen already present in the muscles. The breakdown of the glycogen generates an acid, which leads to reduction of pH in the meat. The amount of electric pulses can be modulated for different types, cuts, and sizes of meat to control the pH reduction. When the substrate includes the thermally and electrically conductive substance, there is an improvement in controlling the rate of cooling by temperature control. The placement of meat in the meat tenderizing device, whether sealed to be fluid tight or fluid restricted, provides a closed system that prevents loss of water from the meat by evaporation or sublimation, which in turn also enhances temperature control. Thus, the control of electrical pulses and control of cooling rate can cooperatively regulate the cooling rate and pH change.

The application of electrical pulses can be performed with two types of electric stimulation: (1) high voltage 800-1140 V at 11-15 H_{z} pulses for 60-90 seconds (e.g., within the first hour); or (2) and low voltage pulses of 32-45 V at 11-15 H_{z} pulses for 60-90 seconds.

Additionally, the closed system provided by the sealed meat tenderizing device can retain freshness of the meat when frozen. The sealed bag (e.g., formed from the bag, sleeve, sheet, strip, or wrap) can inhibit water from escaping from the frozen meat surface when at freezing temperatures. This can also inhibit moisture loss from frozen meat that is inhibited from longitudinal contraction or is longitudinally stretched in the meat tenderizing device.

The PCM can be food grade. For example, a 20% aqueous solution of polyvinylalcohol grafted on chitosan containing 10% by weight of sodium bicarbonate can be used for the food grade PCM. This can allow for use of the PCM for meat processing. The good grade PCM can be beneficial when the PCM directly contacts the meat, the substrate is ruptured to leak PCM onto the meat or leaching of the PCM into the meat takes place. The PCM can be any of the PCM substances that can provide the functions described herein. In some examples, the PCM can be alginate salts of sodium, calcium, or the like. The PCM can be formulated to be a liquid at cooler temperatures and a gel when at warmer temperatures. The change between liquid to gel can be manipulated depending on the meat to be tenderized as well as the meat tenderizing protocol. The PCM can be heated by absorbing heat from the carcass or meat soon after harvest. The PCM may also be heated by external heat applied to the meat tenderizing device containing the meat in order to induce the phase change. The liquid state can allow the PCM to contour with the geometry of the meat before, during or after radial or lateral compression when the PCM returns to the liquid state. During radial or lateral compression, the gel PCM can facilitate increased heat exchange. Also, the gel can be dimensionally larger than the liquid so that the solid expanded state can lead to further radial or lateral compression that can lead to longitudinal stretching or super stretching due to the increase in the volume of the gel radially or laterally outside of the meat even without applying external longitudinal tension.

The meat tenderizing device may also include an inner layer of the substrate and an outer layer of the substrate so that the PCM material is between the inner layer and outer layer. This configuration can provide a jacketing layer containing the PCM.

The meat tenderizing device may also be used in methods for tenderizing meat. The meat tenderizing device can be provided or a sheet can be configured into a bag, sleeve, sheet, strip, or wrap having the meat therein, and the bag, sleeve, sheet, strip, or wrap can then be sealed. The cool liquid PCM can take the geometry of the meat so as to contour with the surface of the meat. The PCM can then solidify and expand in volume or thickness so as to create compressive stresses radially and/or laterally on the meat. The compressive stresses from the expanding PCM can compress the meat so that the muscle fibers are inhibited from longitudinally shortening. The PCM can be designed and prepared so that the compressive forces from expansion can cause longitudinal stretching or lengthening of the muscle fibers and thereby cause longitudinal stretching or lengthening of the meat. The compression can inhibit the meat from undergoing radial or lateral expansion that can occur without compression. This allows for the compression to cause longitudinal stretching of the meat that is guided by the structurally reinforcing members (e.g., fibers) that are in the substrate.

To facilitate placement in the meat tenderizing device, the substrate can be a tubular member with one or two open ends that can slide over the meat before the one or two ends are closed and sealed (e.g., fluid tight seal) so as to form a bag. Alternatively, the meat tenderizing device can be a sheet that has at least one closable system, such as a Ziploc® or zipper, where the meat can be placed on the sheet and the sheet can be folded around the meat before the closable system is closed so as to seal the meat therein. In another alternative, the substrate can be a sheet or strip that is formed into a wrap around the meat.

In one embodiment, the meat tenderizing device can be cooled to a desired temperature before the meat is sealed therein. When the cold substrate contains the meat, the liquid PCM can conform its shape according to the geometry of the meat. The PCM can be cooled to temperature lower than its transition temperature, such as for example the polyvinylalcohol grafted to chitosan in a solution containing 10% sodium bicarbonate has transition temperature equal of 15° C. This allows the meat to become an encapsulated structure so the whole matrix of the meat can be subjected to the homogeneous radial and lateral compression so as to provide longitudinal homogeneous stretching. As the cold PCM absorbs heat from the post-harvest meat by conduction, the PCM can solidify and expand in volume to an expanded solid hydrogel. The expansion can be a 1-10% increase over the original volume. The expansion can apply radial or lateral compression stresses on the meat that leads to additional longitudinal stretching. Once the PCM becomes the expanded hydrogel, the meat tenderizing device can be cooled in a controlled manner. The rate of cooling by this technique can be designed by controlling the thickness of the PCM layer and optionally using the external/internal cooling system. The cooling of the meat in the meat tenderizing device can prevent water loss from the meat, and thereby inhibit drying of the meat and avoiding both hot shortening and cold shortening. Also, any longitudinal shorting may be avoided or significantly reduced. The rate of cooling can be by self-cooling by using a precooled substrate below the transition temperature of the PCM, /or by external cooling such as in a cold room or cooling system.

In one embodiment, electrical stimulation can be applied to the substrate or directly to the carcass or meat via electrodes in order to facilitate breakdown of the glycogen. Otherwise, the glycogen can be broken down by natural enzymes or natural processes in the meat. The breakdown of glycogen has also been found to promote the reduction in pH, and thereby the control of electricity to the meat can control the rate of pH decrease. In one example, the glycogen break down can be facilitated by applying electricity (e.g., high range electric pulse, AC, or DC) to the substrate or directly to the meat so that the electricity is provided to the meat. The electricity can break down the glycogen and control the decrease in pH. For example, the meat tenderizing device containing the carcass can be subjected to high voltage pulses 800V at 14 Hz for 90 seconds.

When the meat reaches a desired or required cooling temperature, the PCM can then liquefy. Once the PCM is liquid, the meat tenderizing device can be removed easily from the meat. The meat tenderizing device can then be prepared for reuse. The meat tenderizing device may be treated with additional liquid PCM or it may be ready to be used immediately after removal from the meat. The PCM and meat tenderizing device may already be at the appropriate cold temperature to start the meat tenderizing process. The meat tenderizing device may also be disposable after one use.

In one embodiment, a stretchable substrate device can be configured as a meat tenderizing device. The device can include: a substrate having at least one structural reinforcing member and include a conductive material that is thermally or electrically conductive, where the at least one structural reinforcing member is positioned so as to control stretching of the substrate; and a phase change member on a surface of at least a portion of the substrate, where the phase change member can include a phase change material (e.g., hydrogel) that is liquid at lower temperatures and a gel at higher temperatures. In one aspect, the at least one structural reinforcing member is selected from the group consisting of a corrugated spiral structure, corrugated tube, or parallel strips, or combinations thereof or other members such as those described herein. In one aspect, the phase change member includes an encapsulated hydrogel pocket. In one aspect, the phase change member is a liner forming a liner layer on the surface of the substrate. In one aspect, the phase change member is on an internal surface of the substrate. In one aspect, the substrate is tubular with openings on opposite ends, which can be closed and sealed. In one aspect, the conductive material is thermally and electrically conductive. In one aspect, the phase change material is a food grade material selected from the group consisting of salt hydrates, sugar alcohols, clathrates, paraffins, fatty acids, polyethylene glycols, chitosans, alginate, algae extracts, bagasse, poly(vinyl alcohol), and combinations thereof having a melting temperature of less than 100° C. In one aspect, the phase change material is a liquid at cooler temperatures below the melting point and gel at higher temperatures above the melting point. In one aspect, the at least one structural reinforcing member is selected from the group consisting of carbon fibers, carboxylated rubber, ionic thermoplastic elastomers, ethylene-propylene-diene rubber, metal, or combinations thereof.

In one embodiment, a method of tenderizing meat can include: providing a stretchable device (e.g., longitudinally stretchable) in accordance with an embodiment described herein; placing meat in the stretchable device; and sealing the stretchable device having the meat therein such that phase change member contours to the meat at a lower temperature below the melting point and then the phase change member expands and solidifies at a higher temperature above the melting point so as to inhibit longitudinal muscle contraction of the meat. In one aspect, the method can include longitudinally stretching the stretchable device so as to longitudinally stretch the meat therein. In one aspect, after placing the meat in the stretchable device, the method can include heating the stretchable device sufficiently to expand and solidify the phase change member to a gel and to stretch the meat, which can be by a heater or otherwise the warm post-harvest meat can provide the heating. The method can also include inhibiting water loss from the meat with the stretchable device. The method can also include inhibiting hot shortening of the meat and inhibiting cold shortening of the meat with the stretchable device. The method can also include controlling a rate of cooling of the phase change member by selecting a thickness of the phase change member. The method can also include applying electricity (e.g., electrical pulses) to the substrate or directly to the meat so as to break down glycogen in the meat. In one aspect, the method can include applying electrical pulses to the substrate or directly to the meat so as to control pH reduction in the meat.

In one example, the pH is measured by using direct liquid indicators or strips that work on the required pH range 3-6, such as thymol blue, bromothymol blue, methyl red, bromocresol cresol purple, ethyl red, resorcin blue, ethyl red, or wide range pH paper 1-14. Controlling the pH is indirectly controlled by temperature cooling rate and electrical stimulation by controlling voltage range, voltage application duration, and frequency.

The method may also include: determining a desired cooled temperature where the phase change member is liquid; and removing the stretchable device from the meat after reaching the desired cooled temperature.

In one embodiment, a meat tenderizing system can include: a stretchable device for meat tenderizing and an electrical device (e.g., electrical pulse device) configured to provide electricity (e.g., electrical pulses) to the substrate or directly to the meat when electrically connected thereto. The electrical device can be any device that can provide electricity to the substrate or directly to the meat so that electricity breaks down the glycogen so as to control the reduction in pH. A computing device may also be included to control the electrical device. The computing device may have computer executable instructions on a non-transitory storage medium that can case the electrical device to follow an electrical protocol to provide the proper electricity to the meat to control the reduction in pH. Different electrical pulse programs can be used for different types of meat, different cuts, and different meat sizes, with or without bone. The computing system may be operably coupled to temperatures sensor and/or pH sensors located in the device so as to receive data from the sensors, and such data can be used in implementing or modulating the meat tenderizing protocol.

In one example, the meat tenderizing device is a double layer substrate made of conductive rubber (e.g., rubber having conductive members or materials distributed therein) with longititual structural reinforcing members, where the conductive rubber is lined with a food grade PCM. The PCM is liquid when colder and a gel (e.g., solid gel) when warmer, and where the gel is a larger volume than the liquid, such that the PCM expands and enlarges to a larger volume when it is heated above the transition temperature. Examples of the PCM include: polyvinylalcohol (PVA) grafted chitosan containing sodium bicarbonate salt (e.g., 10-20% by weight; glycerol 2-phosphate salt and chitosan; poly(ethylene glycol) grafted chitosan; and hydroxy butyl chitosan. When the carcass or meat is contained in the meat tenderizing device (e.g., wrapped with sheet or strips or enclosed in a bag), the PCM will absorb heat from the carcass or meat and then solidify and expanded into a thicker gel, where the expansion applies a compressive force to the carcass or meat to prevent contraction, and to promote expansion when the compressive force is sufficient. The treated carcass or meat is evaluated by measuring the shear force, and comparing the measured shear force to the shear force of similar untreated carcass or meat cut. The PCM may also be selected to have a certain transition temperature and prepared to have a certain thickness when gelled in order to control the cooling process by controlling the cooling rate. During cooling, the pH will drop gradually to a range of 6.3-6, where the pH change rate can be controlled by the cooling rate and also the rate of glycolysis that is stimulated by electrical pulses. An advantage of the PCM expanding from the thin liquid to thicker hydrogel provides flexibility to control the transition temperature by varying the composition of the PCM. For example, the PCM can be varied by modulating the salt concentration in order to select a certain transition temperature or expansion profile.

In one example, a carcass (e.g., whole or portion) is inserted into a meat tenderizing bag having a PCM solution of polyvinyl alcohol grafted to chitosan containing 10% sodium bicarbonate that has a transition temperature about 15° C. At the initial stage, the meat tenderizing bag will be flexible, and as heat is transferred from the carcass to the PCM in the meat tenderizing bag the PCM will solidify and expand into a gel. The expansion applies a compressive force to the carcass that inhibits the muscles from contracting and shortening, or possibly causes the muscles to extend longitidually. The bagged carcass is cooled to below the transition temperature in a cold room, and when the temperature of the carcass is dropped gradually to the desired temperature, the PCM liquifies again and the meat tenderizing bag can be removed. The meat tenderizing bag can be reused or discarded. The meat can be analyzed by measuring the shear force compared to shear force of untreated meat. The meat can be analyzed by monitoring color change, and comparing the color change to the original color and/or to the color of the same type of meat that is: excellent, good, medium, poor, or terrible.

In one example, the PCM is polyvinylalcohol graphted on chitosan at 20% by weight in water having 10% by weight sodium bicarbonate. The PCM is encapsulated in a reinforced rubber bag that has conductive particles or members. The PCM solution is located in a jacketing layer with thickness of about 2-5 cm as an internal lining layer.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

In one embodiment, the present methods can include aspects performed on a computing system. As such, the computing system can include a memory device that has the computer-executable instructions for performing the method. The computer-executable instructions can be part of a computer program product that includes one or more algorithms for performing any of the methods of any of the claims.

In one embodiment, any of the operations, processes, methods, or steps described herein can be implemented by computer-readable instructions stored on a computer-readable medium. The computer-readable instructions can be executed by a processor of a wide range of computing systems from desktop computing systems, portable computing systems, tablet computing systems, hand-held computing systems as well as network elements, and/or any other computing device. The computer readable medium is not transitory. The computer readable medium is a physical medium having the computer-readable instructions stored therein so as to be physically readable from the physical medium by the computer.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the processes that can be implemented or controlled individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a physical signal bearing medium include, but are not limited to, the following: a recordable type medium such as a floppy disk, a hard disk drive, a CD, a DVD, a digital tape, a computer memory, any other physical medium that is not transitory or a transmission. Examples of physical media having computer-readable instructions omit transitory or transmission type media such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those generally found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

The embodiments described herein may include the use of a special purpose or general-purpose computer including various computer hardware or software modules.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other non-transitory medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” can refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computing entity” may be any computing system as previously defined herein, or any module or combination of modulates running on a computing system. Accordingly, the computing system can include a temperature control module, a pH control module that modulates electricity, and a mechanical stretching module.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. A stretchable device for meat tenderizing, the device comprising:
a substrate having at least one structural reinforcing member, the substrate including a conductive material that is thermally and/or electrically conductive, the at least one structural reinforcing member being positioned so as to control stretching of the substrate; and
a phase change member on a surface of at least a portion of the substrate, the phase change member comprising a phase change hydrogel that is liquid at lower temperatures and a solid gel at higher temperatures.

2. The device of claim 1, wherein the at least one structural reinforcing member is selected from the group consisting of a spiral structure, helical structure, corrugated spiral structure, corrugated helical structure, corrugated tube fibers, elongatable fibers, ribbons, flat ribbons, corrugated ribbons, strips, corrugated strips, two or more parallel members, or combinations thereof.

3. The device of claim 1, wherein the phase change member includes an encapsulated hydrogel pocket.

4. The device of claim 1, wherein the phase change member is a liner forming a liner layer on the surface of the substrate.

5. The device of claim 1, wherein the phase change member is on an internal surface of the substrate.

6. The device of claim 1, wherein the substrate is tubular with openings on opposite ends.

7. The device of claim 1, wherein the conductive material is thermally and electrically conductive.

8. The device of claim 1, wherein the phase change material is a food grade material selected from the group consisting of salt hydrates, sugar alcohols, clathrates, paraffins, fatty acids, polyethylene glycols, chitosans, alginate, algae extracts, bagasse, poly(vinyl alcohol), and combinations thereof having a melting temperature of less than 100° C.

9. The device of claim 8, wherein the phase change material is a liquid at cooler temperatures and gel at higher temperatures.

10. The device of claim 1, wherein the at least one structural reinforcing member is selected from the group consisting of carbon fibers, carboxylated rubbers, ionic thermoplastic elastomers, ethylene-propylene-diene rubbers, metals, polyphenylenes, polyanilines, polyaceteylenes, polyesters, polyamides, polyethelenes, polypropylene, cellulose, glass, ceramics, or combinations thereof.

11. A method of tenderizing meat, the method comprising:
providing a stretchable device comprising:
a substrate having at least one structural reinforcing member, the substrate including a conductive material that is thermally or electrically conductive, the at least one structural reinforcing member being positioned so as to control stretching of the substrate; and
a phase change member on a surface of at least a portion of the substrate, the phase change member comprising a phase change hydrogel that is liquid at lower temperatures and a gel at higher temperatures;
placing meat in the stretchable device; and
sealing the stretchable device having the meat therein such that phase change member contours to the meat at a lower temperature and then the phase change member expands and solidifies at a higher temperature so as to inhibit muscle contraction of the meat.

12. The method of claim 11, comprising stretching the stretchable device so as to stretch the meat therein.

13. The method of claim 11, comprising after placing the meat in the stretchable device, heat transfer from the meat to the stretchable device to expand and solidify the phase change member to a gel and to stretch the meat.

14. The method of claim 11, comprising inhibiting water loss from the meat with the stretchable device.

15. The method of claim 11, comprising inhibiting hot shortening of the meat and inhibiting cold shortening of the meat with the stretchable device.

16. The method of claim 11, comprising controlling a rate of cooling of the phase change member by selecting a thickness of the phase change member.

17. The method of claim 11, comprising applying electrical pulses to the conductive material in the substrate so as to break down glycogen in the meat.

18. The method of claim 11, comprising applying electrical pulses to the conductive material in the substrate so as to control pH reduction in the meat.

19. The method of claim 11, comprising:
determining a desired cooled temperature where the phase change member is liquid; and
removing the stretchable device from the meat after reaching the desired cooled temperature.

20. A meat tenderizing system comprising:
a stretchable device for meat tenderizing, the device comprising:
a substrate having at least one structural reinforcing member, the substrate including a conductive material that is thermally or electrically conductive, the at least one structural reinforcing member being located so as to control stretching of the substrate; and
a phase change member on a surface of at least a portion of the substrate, the phase change member comprising a phase change hydrogel that is liquid at lower temperatures and a solid gel at higher temperatures;
an electrical pulse device configured to provide electrical pulses to the conductive material of the substrate when electrically connected thereto.
